(19) United States
(12) Patent Application Publication
(10) Pub. No.: US 2026/0260473 A1
(43) Pub. Date: Sep. 3, 2026

(54) TRAINING APPARATUS, TRAINING METHOD, AND NON-TRANSITORY COMPUTER-READABLE STORAGE MEDIUM

(71) Applicant: NEC Corporation, Minato-ku, Tokyo (JP)

(72) Inventors: Tsenjung TAI, Tokyo (JP); Kenta SENZAKI, Tokyo (JP); Masato TODA, Tokyo (JP); Elji KANEKO, Tokyo (JP)

(73) Assignee: NEC Corporation, Minato-ku, Tokyo (JP)

(21) Appl. No.: 18/875,197

(22) PCT Filed: Sep. 27, 2022
(86) PCT No.: PCT/JP2022/035809

§ 371 Date: Dec. 16, 2024

(51) Int. Cl. G06V 10/82; G06N 3/04; G06N 3/08; G06V 10/77; G06V 20/10

(52) U.S. Cl. CPC G06V 10/82; G06N 3/04; G06N 3/08; G06V 10/7715; G06V 20/194

(57) ABSTRACT

A training apparatus acquires a training data that includes a training image, first angle information, and a ground truth data. The first angle information indicates a first incident angle and a first azimuth angle. The training apparatus inputs the training image to a feature extracting model to acquire a first feature set. The training apparatus acquires second angle information (90), performs coordinate transformation on the first feature set based on the first angle information and the second angle information to generate a second feature set, and updates the feature extracting model based on the first feature set, the second feature set, and the ground truth data.

### TECHNICAL FIELD

The present disclosure generally relates to training apparatus, training method, and non-transitory computer-readable storage medium.

### BACKGROUND ART

There are techniques to analyze an image with a model that extracts features from the image: e.g., object classification with neural networks. PTL1 discloses a system including a convolutional neural network (CNN) unit that is configured to take an image generated by a synthetic-aperture radar as input and classify an object captured on the input image. This system includes a function to increase data to be used for the training of the CNN unit. Specifically, this system acquires a training data that includes a training image and a ground truth data, and generates another image by changing a location, an orientation, or both of an object captured on the training image. Then, both the training image and the image generated by the system are used to train the CNN unit.

### CITATION LIST

### Patent Literature

PTL1: Japanese Unexamined Patent Application Publication No. 2019-125203

### SUMMARY OF INVENTION

### Technical Problem

Generating another image based on a given image is the only way disclosed by PTL1 to increase data to be used for the training of a model that handles images. An objective of the present disclosure is to provide a novel technique to train a model that handles images.

### Solution to Problem

The present disclosure provides a training apparatus that comprises at least one memory that is configured to store instructions and at least one processor.

The at least one processor is configured to: acquire a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image; input the training image to a feature extracting model to acquire a first feature set that is a set of features extracted from the training image; acquire second angle information that indicates a second incident angle and a second azimuth angle, wherein the second incident angle, the second azimuth angle, or both are different from counterparts thereof in the first angle information; generate a second feature set by performing coordinate transformation on the first feature set based on the first angle information and the second angle information; and update the feature extracting model based on the first feature set, the second feature set, and the ground truth data.

The present disclosure further provides a training method that is performed by a computer, comprises: acquiring a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image; inputting the training image to a feature extracting model to acquire a first feature set that is a set of features extracted from the training image; acquiring second angle information that indicates a second incident angle and a second azimuth angle, wherein the second incident angle, the second azimuth angle, or both are different from counterparts thereof in the first angle information; generating a second feature set by performing coordinate transformation on the first feature set based on the first angle information and the second angle information; and updating the feature extracting model based on the first feature set, the second feature set, and the ground truth data.

The present disclosure further provides a non-transitory computer readable storage medium storing a program.

The program that causes a computer to execute: acquiring a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image; inputting the training image to a feature extracting model to acquire a first feature set that is a set of features extracted from the training image; acquiring second angle information that indicates a second incident angle and a second azimuth angle, wherein the second incident angle, the second azimuth angle, or both are different from counterparts thereof in the first angle information; generating a second feature set by performing coordinate transformation on the first feature set based on the first angle information and the second angle information; and updating the feature extracting model based on the first feature set, the second feature set, and the ground truth data.

### Advantageous Effects of Invention

According to the present disclosure, a novel technique to train a model that handles images is provided.

### BRIEF DESCRIPTION OF DRAWINGS

FIG. 1 illustrates an overview of a training apparatus of the first example embodiment.

FIG. 2 illustrates an example of the training data.

FIG. 3 is a block diagram showing an example of the functional configuration of the training apparatus of the first example embodiment.

FIG. 4 is a block diagram illustrating an example of the hardware configuration of a computer realizing the training apparatus of the first example embodiment.

FIG. 5 shows a flowchart illustrating an example flow of process performed by the training apparatus of the first example embodiment.

FIG. 6 illustrates the feature extraction performed by the feature extracting model.

FIG. 7 illustrates how the incident angle affects the appearance of the object captured on a radar image.

FIG. 8 illustrates a coordinate transformation from the first coordinate system to the second coordinate system.

FIG. 9 illustrates another example of the transformation from the first feature set 80 into the second feature set 100.

FIG. 10 illustrates the feature modification using the first angle information and the second angle information.

FIG. 11 illustrates an example of ways to extract features from a set of the first angle information and the second angle information.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage unit to which a computer using that information has access unless otherwise described. In the present disclosure, a storage unit may be implemented with one or more storage devices, such as hard disks, solid-state drives (SSDs), or random-access memories (RAMs).

### First Example Embodiment

### Overview

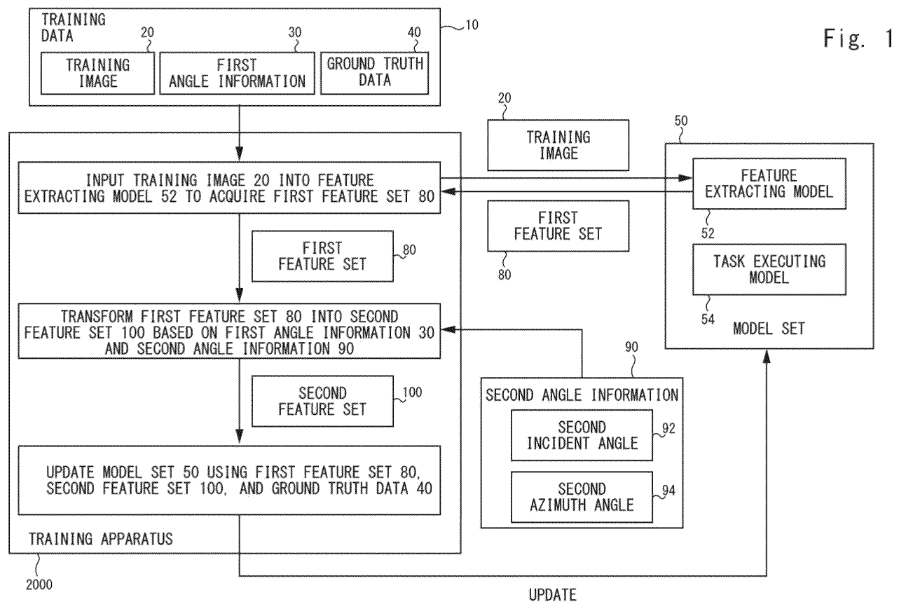

FIG. 1 illustrates an overview of a training apparatus 2000 of the first example embodiment. It is noted that FIG. 1 does not limit operations of the training apparatus 2000, but merely show an example of possible operations of the training apparatus 2000.

The training apparatus 2000 is an apparatus that is configured to acquire a training data 10 and train a model set 50 using the training data 10. The model set 50 includes a feature extracting model 52 and task executing model 54. The feature extracting model 52 and the task executing model 54 may be machine learning-based model, such as neural networks.

The feature extracting model 52 is configured to take an image as input, extract features from the input image, and output the extracted features. The task executing model 54 is configured to take the features as input, perform task on the input features, and output a result of task. Examples of the task performed by the task executing model 54 are object detection, object classification, semantic segmentation, image reconstruction, etc.

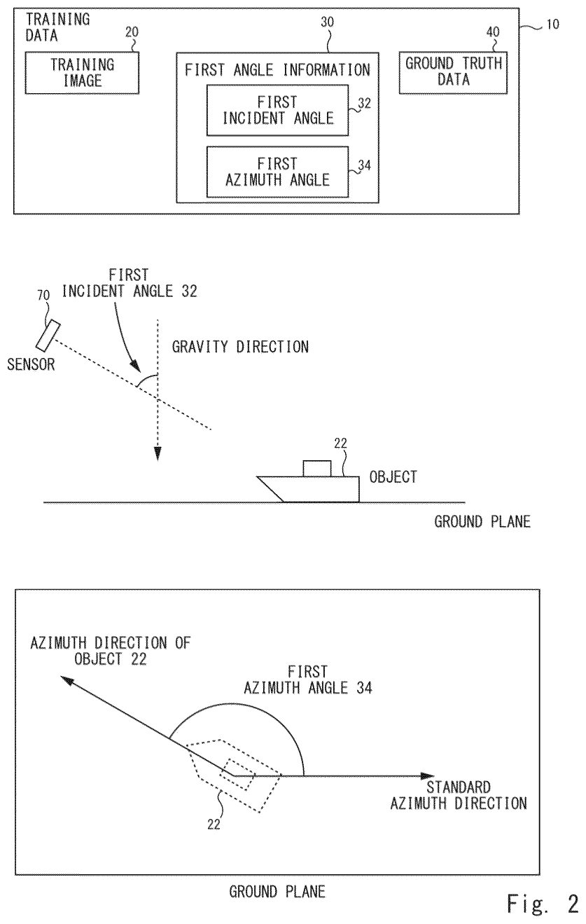

The training data 10 includes a training image 20, first angle information 30, and a ground truth data 40. FIG. 2 illustrates an example of the training data 10. The training image 20 is an image that is generated by a sensor 70 and includes an object 22. The training image 20 may be an optical image or a radar image.

When the training image 20 is an optical image, the sensor 70 is an optical camera that is configured to receive light to generate an optical image based on the received light. When the training image 20 is a radar image, the sensor 70 is a radar that is configured to transmit radio waves, receive reflection of the radio waves, and generate a radar image based on the received reflection of the radio waves. The sensor 70 may be installed on an artificial satellite to capture objects on the Earth, other planets, satellites, etc. An example of radar is a synthetic-aperture radar.

The first angle information 30 indicates a first incident angle 32 and a first azimuth angle 34. The first incident angle 32 represents an incident angle of the sensor 70 at the time of the sensor 70 capturing the object 22 to generate the training image 20. The first azimuth angle 34 is an azimuth angle of the object 22 at the time of the sensor 70 capturing the object 22 to generate the training image 20.

The ground truth data 40 is a data that indicates ground truth for the training of the model set 50. Suppose that the model set 50 performs object classification on an image. Since the object 22 is a ship in FIG. 2, the ground truth data 40 indicates a class of “ship”.

To train the model set 50, the training apparatus 2000 may operate as follows. The training apparatus 2000 acquires the training data 10, and inputs the training image 20 in the acquired training data 10 into the feature extracting model 52. As a result, the training apparatus 2000 acquires a first feature set 80, which is a set of features extracted from the training image 20 by the feature extracting model 52.

The training apparatus 2000 generates another feature set, called “second feature set 100” from the first feature set 80 to train the model set 50. To do so, the training apparatus 2000 further acquires second angle information 90, which indicates a second incident angle 92 and a second azimuth angle 94. The second incident angle 92 is not equal to the first incident angle 32, the second azimuth angle 94 is not equal to the first azimuth angle 34, or both.

The training apparatus 2000 performs coordinate transformation on the first feature set 80 based on the first angle information 30 and the second angle information 90, thereby transforming the first feature set 80 into the second feature set 100. By doing so, the second feature set 100 is generated so that it represents features of an image with the second incident angle 92 and the second azimuth angle 94. Specifically, the second feature set 100 represents features of an image that is captured by the sensor 70 having an incident angle equal to the second incident angle 92 and on which the object 22 having the azimuth angle equal to the second azimuth angle 94 is captured.

The training apparatus 2000 trains the model set 50 using the first feature set 80, the second feature set 100, and the ground truth data 40. Details of the training of the model set 50 will be explained later.

### Example of Advantageous Effect

It is preferable to use multiple images with various pairs of the incident angle and the azimuth angle to train the model set 50. In particular, when the images are generated by a radar, an incident angle of the radar and an azimuth angle of an object to be captured may affect appearance of the object on the image due to the nature of radar imaging physics as explained in detail later. However, there would be some situations in which it is difficult to prepare a sufficient number of images for the training of the model.

According to the training apparatus 2000, a novel technique to train a model that handles images is provided. Specifically, the first feature set 80 is extracted from the training image 20, and the second feature set 100 is generated by performing coordinate transformation on the first feature set 80. Then, both the first feature set 80 and the second feature set 100 are used to train the model set 50.

The second feature set 100 represents features of an image that is captured by the sensor 70 with a specific incident angle and on which the object 22 with a specific azimuth angle is captured. By generating the second feature set 100 from the first feature set 80, the training apparatus 2000 can obtain features of another image without actually obtaining that image. Thus, the training apparatus 2000 can increase the number of sets of features of images to be used for the training of the model set 50, thereby facilitating collection of training data for the training of the model set 50. In addition, the training apparatus 2000 can facilitate improving accuracy of the model set 50.

Hereinafter, more detailed explanation of the training apparatus 2000 will be described.

### <Example of Functional Configuration>

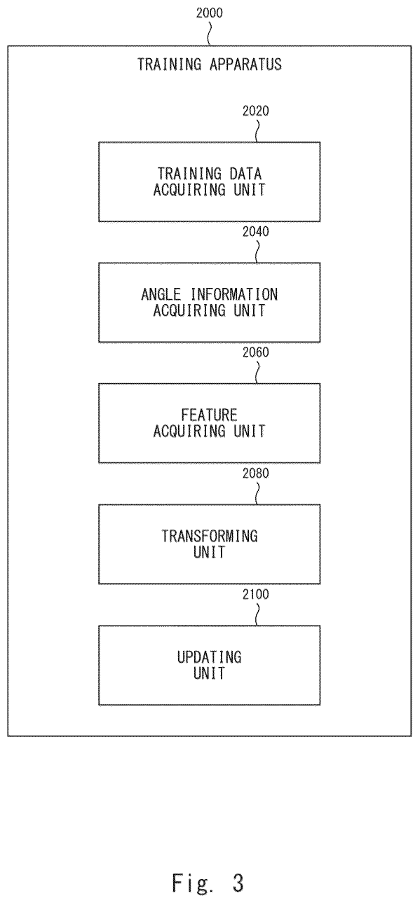

FIG. 3 is a block diagram showing an example of the functional configuration of the training apparatus 2000 of the first example embodiment. The training apparatus 2000 includes a training data acquiring unit 2020, an angle information acquiring unit 2040, a feature acquiring unit 2060, a transforming unit 2080, and an updating unit 2100.

The training data acquiring unit 2020 acquires the training data 10. The angle information acquiring unit 2040 acquires the second angle information 90. The feature acquiring unit 2060 inputs the training image 20 into the feature extracting model 52 to acquire the first feature set 80 that is extracted from the training image 20 by the feature extracting model 52. The transforming unit 2080 performs coordinate transformation on the first feature set 80 based on the first angle information 30 and the second angle information 90, thereby transforming the first feature set 80 into the second feature set 100. The updating unit 2100 updates the model set 50 using the first feature set 80, the second feature set 100, and the ground truth data 40.

### <Example of Hardware Configuration>

The training apparatus 2000 may be realized by one or more computers. Each of the one or more computers may be a special-purpose computer manufactured for implementing the training apparatus 2000, or may be a general-purpose computer like a personal computer (PC), a server machine, or a mobile device.

The training apparatus 2000 may be realized by installing an application in the computer. The application is implemented with a program that causes the computer to function as the training apparatus 2000. In other words, the program is an implementation of the functional units of the training apparatus 2000. There are various ways to acquire the program. For example, the program can be acquired from a storage medium (such as a DVD disk or a USB memory) in which the program is stored in advance. In another example, the program can be acquired by downloading it from a server machine that manages a storage medium in which the program is stored in advance.

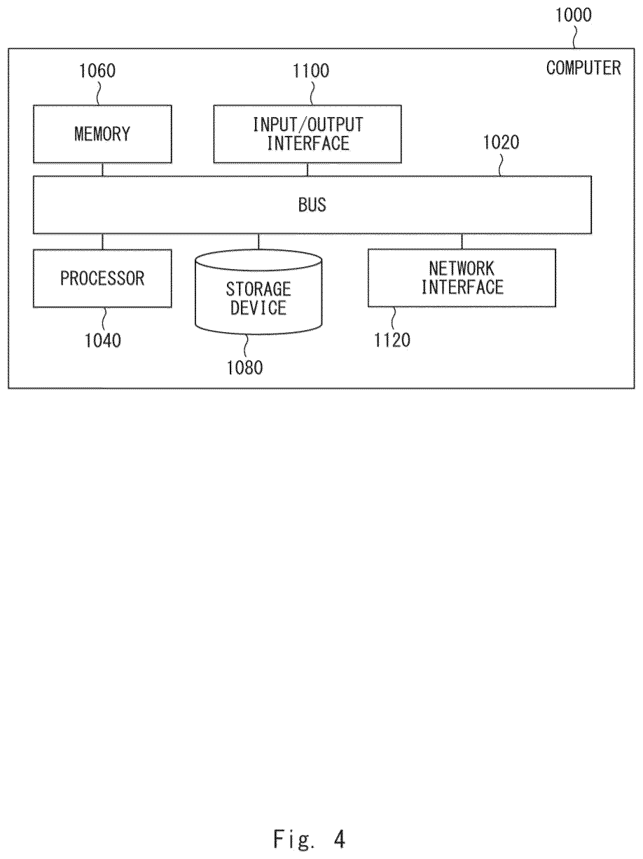

FIG. 4 is a block diagram illustrating an example of the hardware configuration of a computer 1000 realizing the training apparatus 2000 of the first example embodiment. In FIG. 4, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), FPGA (Field-Programmable Gate Array), or a DSP (Digital Signal Processor). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network). The storage device 1080 may store the program mentioned above. The processor 1040 executes the program to realize each functional unit of the training apparatus 2000.

The hardware configuration of the computer 1000 is not restricted to that shown in FIG. 4. For example, as mentioned-above, the training apparatus 2000 may be realized by plural computers. In this case, those computers may be connected with each other through the network.

### <Flow of Process>

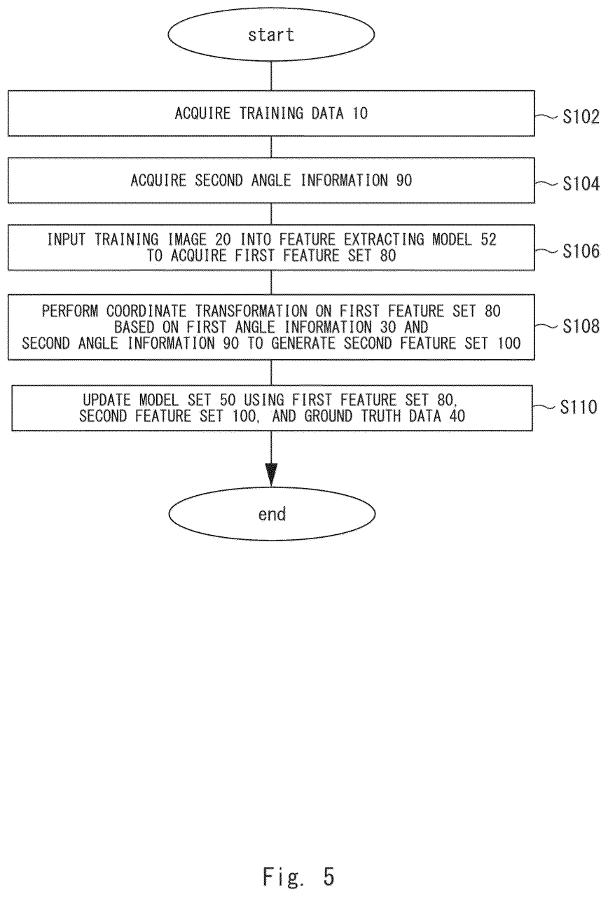

FIG. 5 shows a flowchart illustrating an example flow of process performed by the training apparatus 2000 of the first example embodiment. The training data acquiring unit 2020 acquires the training data 10 (S102). The angle information acquiring unit 2040 acquires the second angle information 90 (S104). The feature acquiring unit 2060 inputs the training image 20 into the feature extracting model 52 to acquire the first feature set 80 (S106). The transforming unit 2080 performs coordinate transformation on the first feature set 80 based on the first angle information 30 and the second angle information 90 to transform the first feature set 80 into the second feature set 100 (S108). The updating unit 2100 updates the model set 50 using the first feature set 80, the second feature set 100, and the ground truth data 40 (S110).

It is noted that FIG. 5 illustrates a merely example of possible flows of process performed by the training apparatus 2000, and a flow of process performed by the training apparatus 2000 is not limited to that shown by FIG. 5. For example, the acquisition of the second angle information 90 (S104) may be performed at any timing before the coordinate transformation (S108).

### <Acquisition of Training Data 10: S102>

The training data acquiring unit 2020 acquires the training data 10 (S102). There are various ways to acquire the training data 10. In some implementations, the training data acquiring unit 2020 may receive the training data 10 that is sent from another computer, such as one generates the training data 10. In other implementations, the training data may be stored in advance in a storage unit to which the training data acquiring unit 2020 has access. In this case, the training data acquiring unit 2020 reads the training data 10 out of this storage unit.

It is noted that two or more training data 10 may be acquired by the training data acquiring unit 2020. In this case, the training apparatus 2000 may use each of them to train the model set 50.

There may be various ways to determine the number of the training data 10 to be acquired. For example, the number of the training data 10 to be acquired may be defined in advance, randomly determined by the training data acquiring unit 2020, or specified by a user of the training apparatus 2000. In another example, the training data acquiring unit 2020 may acquire all the training data 10 prepared (e.g., all the training data 10 stored in the storage device).

### <Acquisition of Second Angle Information 90: S104>

The angle information acquiring unit 2040 acquires the second angle information 90 (S104). It is noted that the number of pieces of the second angle information 90 acquired by the angle information acquiring unit 2040 may not be limited to one. When the angle information acquiring unit 2040 acquires two or more pieces of the second angle information 90, the transforming unit 2080 may generate the second feature set 100 for each second angle information 90.

There may be various ways to determine the number of pieces of the second angle information 90 to be acquired. For example, the number of pieces of the second angle information 90 to be acquired may be defined in advance, randomly determined by the angle information acquiring unit 2040, or specified by a user of the training apparatus 2000. In another example, the angle information acquiring unit 2040 may acquire all the second angle information 90 prepared (e.g., all the second angle information 90 stored in ae storage device).

The second angle information 90 may be prepared in advance or dynamically generated by the angle information acquiring unit 2040. In the former case, as candidates of the second angle information 90, various pairs of an incident angle and an azimuth angle may be stored in advance in a storage device to which the training apparatus 2000 has access. The angle information acquiring unit 2040 may acquire the second angle information 90 from this storage device by choosing, as the second angle information 90, one of those candidates whose second incident angle 92, second azimuth angle 94, or both are not equivalent to those counterparts of the first angle information 30. The candidate of the second angle information 90 may be chosen randomly or based on a specific rule.

In the case where the second angle information 90 is dynamically generated, the angle information acquiring unit 2040 may randomly determine the second incident angle 92 and the second azimuth angle 94 to generate the second angle information 90. If the second incident angle 92 and the second azimuth angle 94 respectively equal to the first incident angle 32 and the first azimuth angle 34, the training apparatus 2000 may randomly determine the second incident angle 92, the second azimuth angle 94, or both again so that the second angle information 90 becomes inequivalent to the first angle information 30.

### <Acquisition of First Feature Set 80: S106>

The feature acquiring unit 2060 inputs the training image 20 into the feature extracting model 52 to acquire the first feature set 80 (S106). The feature extracting model 52 is configured to extract features of an image input thereinto and output the extracted features. Thus, when the feature acquiring unit 2060 inputs the training image 20 into the feature extracting model 52, the feature extracting model 52 extracts features of the training image 20 and output the features extracted from the training image 20. The feature acquiring unit 2060 acquires the features of the training image 20 output from the feature extracting model 52 as the first feature set 80.

Hereinafter, the feature extracting model 52 is explained in more detail.

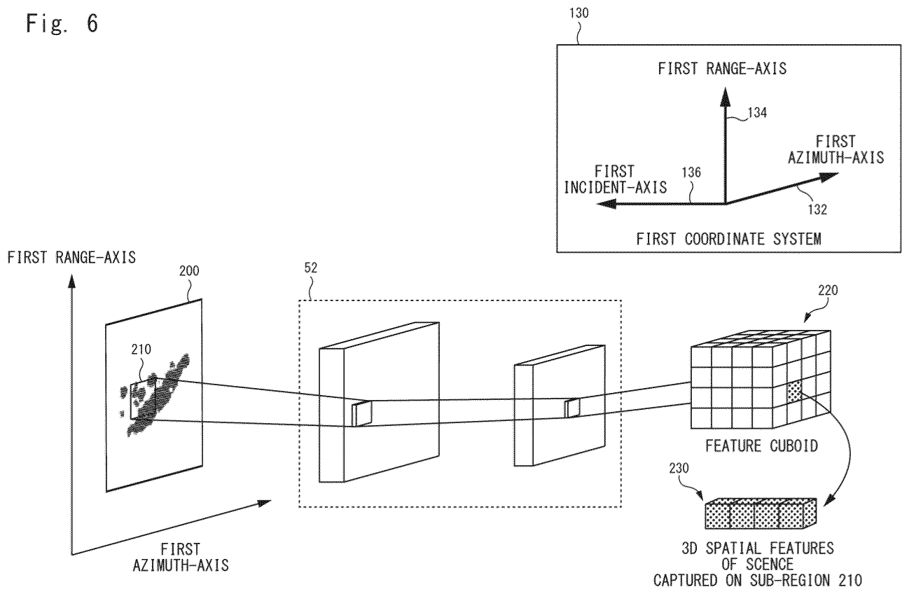

The feature extracting model 52 is configured to extract three-dimensional spatial features of the scene captured on an input image. FIG. 6 illustrates the feature extraction performed by the feature extracting model 52. The feature extracting model 52 may be configured as a neural network, such as a convolutional neural network (CNN), that has a plurality of filters to extract a plurality of local spatial features for each sub-region 210 of an image 200 input thereinto.

The feature extracting model 52 may be trained to generate a set of features of the input image 200, which may be represented by a set of cells that has a feature vector (i.e., value of features) and coordinates in a specific coordinate system. It is noted that, in this disclosure, a term “cell” is used to describe a pair of a value and coordinates. The feature vector corresponding to specific coordinates represents spatial features of a three-dimensional sub-region of the scene corresponding to those coordinates. The set of cells may be represented by a cuboid of cells each of which indicates the feature vector corresponding to the coordinates of the cell. Hereinafter, this cuboid of cells is called “feature cuboid”.

Hereinafter, unless otherwise stated, the set of features extracted by the feature extracting model 52 is described as being a feature cuboid. However, the techniques described in this disclosure can also be applied to cases where the set of features extracted by the feature extracting model 52 is represented by a form other than cuboid (e.g., a list of cells).

The feature cuboid 220 generated by the feature extracting model 52 is a cuboid in a first coordinate system 130, which is defined by a first azimuth-axis 132, a first range-axis 134, and a first incident-axis 136. The first azimuth-axis 132 is an axis that is on the ground plane and represents a standard azimuth direction (e.g., East). The first range-axis 134 is an axis that is on the ground plane and perpendicular to the first azimuth-axis 132. The first incident-axis 136 is an axis that forms the incident angle of the input image from a direction opposite to the gravity direction, called “elevation direction”. As illustrated by FIG. 6, features of the sub-region 210 of the input image 200 may be extracted as a sequence of cells of the feature cuboid 220 along the first incident-axis 136. Hereinafter, this sequence of cells is called “cell sequence 230”.

When the training image 20 is input into the feature extracting model 52, the incident angle of the input image is the first incident angle 32. Thus, the first coordinate system corresponding to the first feature set 80 can be defined by the first incident angle 32.

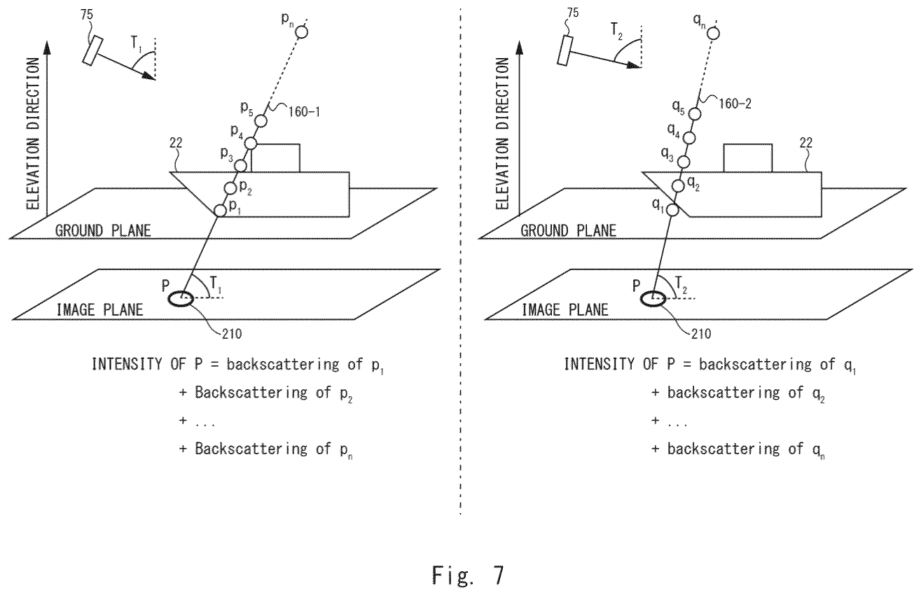

Hereinafter, the first feature set 80 is further explained from the viewpoint of the nature of radar imaging physics. As mentioned above, according to the nature of radar imaging physics, the incident angle of the radar and the azimuth angle of the object affect appearance of the object captured on the image. FIG. 7 illustrates how the incident angle affects the appearance of the object captured on a radar image.

The example on the left side of FIG. 7 and the example on the right side of FIG. 7 are different in the incident angle of a radar 75. In the left side example, there is a line 160-1 that passes through a sub-region 210 and forms the incident angle T1 from the ground plane. Thus, the line 160-1 passes through three-dimensional space in a real world that is projected on the sub-region 210 on an image plane of the image 200.

On the other hand, in the right side example, there is a line 160-2 that passes through the sub-region 210 and forms the incident angle T2 from the ground plane. Thus, the line 160-2 passes through three-dimensional space in the real world that is projected on the sub-region 210 on the image plane of the image 200.

By the nature of radar imaging physics, intensity of the sub-region 210 can be computed as a sum of backscattering of points along the line 160. Thus, in the left side example, the intensity of the sub-region 210 is a sum of the backscattering of p1 to pn. Similarly, in the right side example, the intensity of the sub-region 210 is a sum of backscattering of q1 to qn. This means that the intensity of the sub-region 210 on the image 200 depends on the incident angle of the radar 75.

In addition, points of the object 22 that are along the line 160 change when the azimuth angle of the object 22 are changed. Thus, it can be also said that the azimuth angle of the object 22 affects intensity of the sub-region 210 on the image 200 by the nature of radar imaging physics.

As mentioned with referring to FIG. 6, the features of the sub-region 210 of the image 200 may be extracted as the sequence 230, which is a sequence of cells along the first incident-axis 136. The direction represented by the first incident-axis 136 is equivalent to the direction of the line 160. Thus, the feature extracting model 52 may be trained to generate the feature cuboid 220 that includes, for each sub-region 210, the sequence 230 that represents features of points along the line 160 that passes through that sub-region 210.

### <Coordinate Transformation: S108>

The transforming unit 2080 performs coordinate transformation on the first feature set 80 based on the first angle information 30 and the second angle information 90 to generate the second feature set 100 (S108). The coordinate transformation performed by the transforming unit 2080 is a coordinate transformation from the first coordinate system 130 defined by the first angle information 30 to a second coordinate system defined by the second angle information 90.

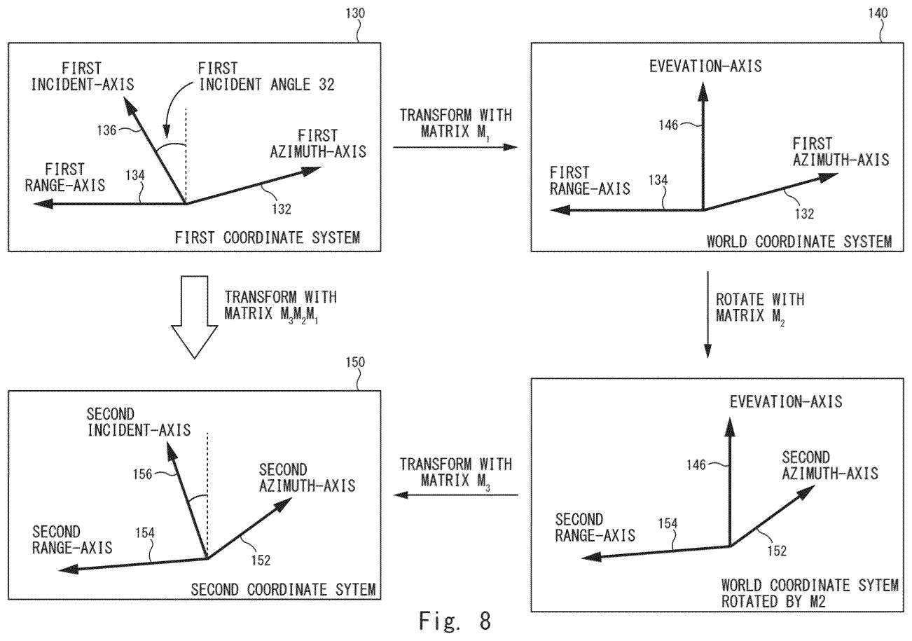

FIG. 8 illustrates a coordinate transformation from the first coordinate system 130 to the second coordinate system 150. This coordinate transformation can be broken down into a first to a third coordinate transformations.

The first coordinate transformation M1 is a coordinate transformation from the first coordinate system 130 to a world coordinate system 140.

The world coordinate system 140 is a coordinate system of the real world that is defined by a first azimuth-axis 132, a first range-axis 134, and an elevation-axis 146. The elevation-axis 146 is an axis that represents a direction opposite to the gravity direction.

The second coordinate transformation M2 is a rotation of the world coordinate system 140 by a rotation angle, which is defined by a difference between the second azimuth angle 94 and the first azimuth angle 34. By the second coordinate transformation, a second azimuth-axis 152 and a second range-axis 154 are obtained by rotating the first azimuth-axis 132 and the first range-axis 134 about the elevation-axis, respectively. Suppose that the first azimuth angle 34 and the second azimuth angle 94 are S1 and S2, respectively. In this case, the second azimuth-axis 152 and the second range-axis 154 are obtained by respectively rotating the first azimuth-axis 132 and the first range-axis 134 about the elevation-axis by S2-S1.

The third coordinate transformation M3 is a coordinate transformation from the world coordinate system 140 rotated by the rotation angle to the second coordinate system 150. The second coordinate system 150 is a coordinate system that is defined by the second azimuth-axis 152, the second range-axis 154, and a second incident-axis 156. The second incident-axis 156 is an axis that forms the second incident angle 92 from the elevation-axis 146.

In FIG. 8, the first coordinate transformation, the second coordinate transformation, and the third coordinate transformation are represented by a transformation matrix M1, M2, and M3, respectively. Under this assumption, the coordinate transformation from the first coordinate system 130 to the second coordinate system 150 can be represented as follows:

$$( \begin{matrix}{x}_{2} \\ {y}_{2} \\ {z}_{2}\end{matrix} ) = {M}_{c} ( \begin{matrix}{x}_{1} \\ {y}_{1} \\ {z}_{1}\end{matrix} ) \qquad Expression 1$$

$${M}_{c} = {M}_{3} {M}_{2} {M}_{1}$$

where (x1,y1,z1) and (x2,y2,z2) represent coordinates in the first coordinate system 130 and those in the second coordinate system 150, respectively. Mc represents a combined transformation matrix, which directly represents the coordinate transformation from the first coordinate system 130 to the second coordinate system 150.

The transforming unit 2080 determines the transformation matrix M1, M2, and M3, thereby determining the combined transformation matrix Mc. It is noted that there are well-known ways to compute a transformation matrix between two coordinate systems, and one of those ways can be applied to the transforming unit 2080 to determine the transformation matrix M1, M2, and M3.

As mentioned above, the first feature set 80 can be represented by a cuboid of cells in the first coordinate system 130. The transforming unit 2080 obtains, as the second feature set 100, a cuboid of cells in the second coordinate system 150 by transforming the cuboid of cells of the first feature set 80 using the transformation matrix Mc.

Specifically, the transforming unit 2080 may use the transformation matrix Mc to transform coordinates of each cell of the first feature set 80 in the first coordinate system 130 into coordinates in the second coordinate system 150. By doing so, the transforming unit 2080 determines a cell of the second feature set 100 that corresponds to the cell of the first feature set 80. Then, the transforming unit 2080 sets a value of the cell of the first feature set 80 to the corresponding cell of the second feature set 100.

Suppose that (x1, y1,z1) in the first coordinate system 130 is transformed into (x2,y2,z2) in the second coordinate system 150 by the coordinate transformation with the combined transformation matrix Mc. In this case, the transforming unit 2080 may set the value of the cell at (x1, y1, z1) of the first feature set 80 to the cell at (x2, y2, z2) of the second feature set 100.

In another example, the transforming unit 2080 may compute an inverse of the combined matrix Mc, which is denoted by Mc\hat{ }−1, to compute the second feature set 100. In this case, the transforming unit 2080 transforms coordinates of each cell of the second feature set 100 in the second coordinate system 150 into coordinates in the first coordinate system 130. By doing so, the transforming unit 2080 determines a cell of the first feature set 80 that corresponds to the cell of the second feature set 100. Then, the transforming unit 2080 sets a value of the cell of the first feature set 80 to the corresponding cell of the second feature set 100.

<<Feature Modification with Trainable Model>>

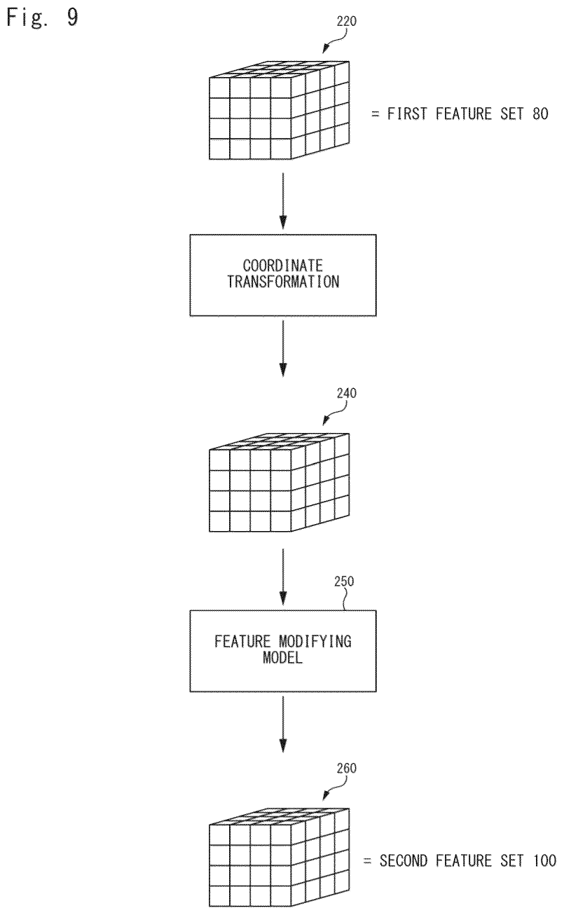

The transforming unit 2080 may further perform feature modifications with a trainable model called “feature modifying model” after the coordinate transformation mentioned above. FIG. 9 illustrates another example of the transformation from the first feature set 80 into the second feature set 100. The transforming unit 2080 first performs the coordinate transformation on the feature cuboid 220 that has been obtained as the feature set 80, thereby obtaining a feature cuboid 240. Then, the transforming unit 2080 inputs the feature cuboid 240 into a feature modifying model 250.

The feature modifying model 250 is configured to take as input the feature cuboid 240 and modify a value of the cells of the feature cuboid 240 to output a feature cuboid 260. The transforming unit 2080 outputs the feature cuboid 260 as the second feature set 100.

The feature modifying model 250 may be implemented as a machine learning-based model, such as a neural network. There are various ways to modify the feature cuboid 240 to generate the second feature set 100. For example, the feature modifying model 250 may be configured to compute, for each cell of the feature cuboid 240, a weighted sum of the value of that cell and the values of the surrounding (e.g., adjacent) cells. The weighted sum computed for a cell of the feature cuboid 240 is set to the corresponding cell of the feature cuboid 260. In this case, weights are parameters to be trained.

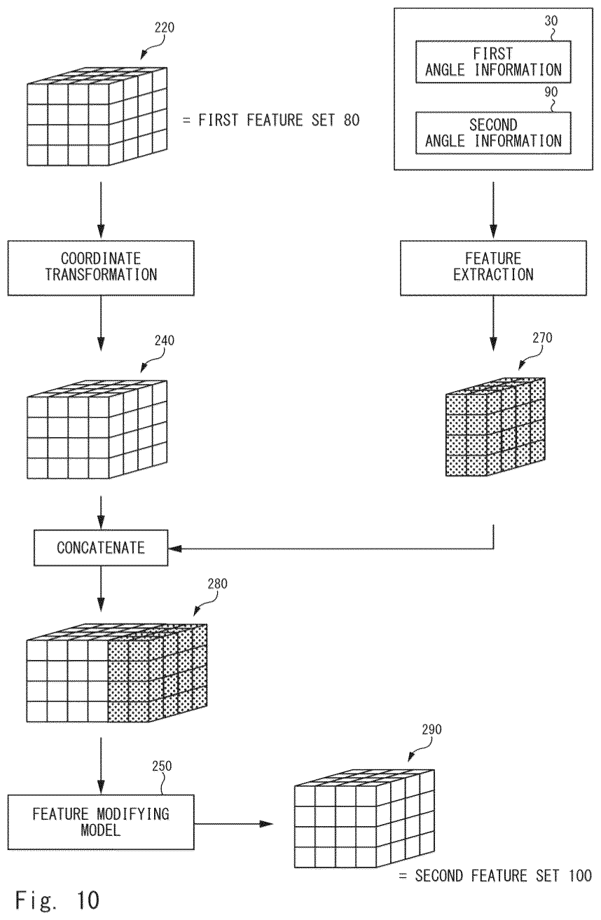

In another example, the first angle information 30 and the second angle information 90 are also used for the feature modification. FIG. 10 illustrates the feature modification using the first angle information 30 and the second angle information 90. The transforming unit 2060 may compute features of difference between the first angle information 30 and the second angle information 90 to generate a feature cuboid 270. The transforming unit 2060 concatenates the feature cuboid 270 with the feature cuboid 240 to obtain a feature cuboid 280. As illustrated by FIG. 10, the feature cuboid 270 is configured to have the same size as the feature cuboid 240 along the second azimuth-axis 152 and the second range-axis 154 so that the feature cuboid 270 can be concatenated to the feature cuboid 240.

Then, the transforming unit 2060 inputs the feature cuboid 280 into the feature modifying model 250, thereby obtaining a feature cuboid 290 as the second feature set 100. In this case, the feature modifying model 250 is configured to take the feature cuboid 280 as input and output the feature cuboid 290. To convert the feature cuboid 280 into the feature cuboid 290, the feature modifying model 250 is configured to use the values of cells of the feature cuboid 270 to modify values of cells of the feature cuboid 240.

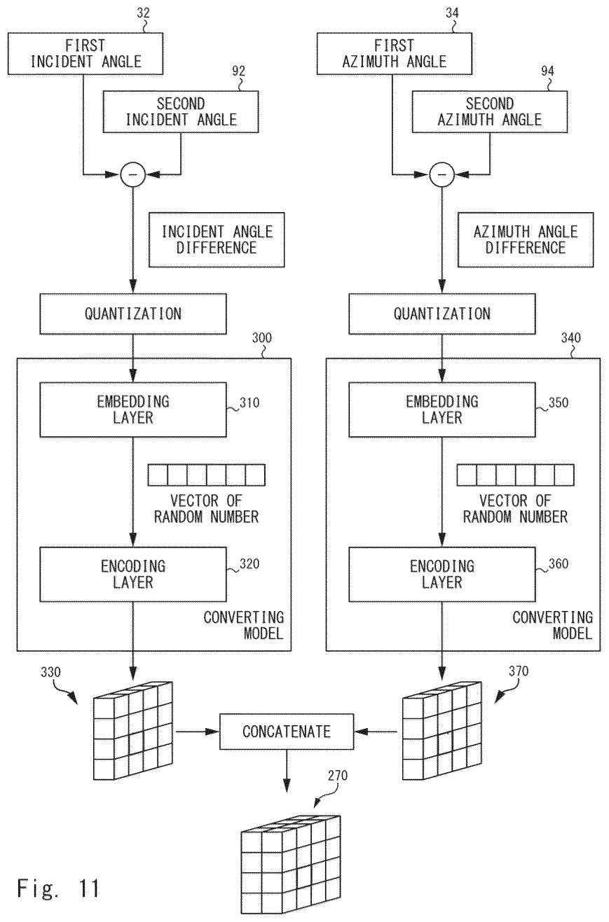

There are various ways to extract features from a set of the first angle information 30 and the second angle information 90. FIG. 11 illustrates an example of ways to extract features from a set of the first angle information 30 and the second angle information 90. Briefly, the transforming unit 2060 computes a difference between the incident angles (hereinafter, called “incident angle difference”) and a difference between the azimuth angles (hereinafter, “azimuth angle difference”). Then, the transforming unit 2060 computes features of the incident angle difference and those of the azimuth angle difference, and concatenates them to obtain the feature cuboid 270.

Hereinafter, an example way of computing the features of the incident angle difference is explained below first. The transforming unit 2060 computes the incident angle difference (i.e., the difference between the first incident angle 32 and the second incident angle 92) and quantizes the incident angle difference to obtain one of predefined integers.

In some implementations, the entire range of the incident angle (e.g., 360°) is divided into a specific interval to define the predefined integers. For example, when the entire range of the incident angle is 360° and the interval of the division is 10°, the entire rage of the indent angle is divided into 36 bins. In this case, 1 to 36 are used as the predefined integers. Suppose that the incident angle difference is 35°. In this case, the incident angle difference is quantized to 4 since 35° belongs to the fourth bin.

The transforming unit 2060 inputs the quantized incident angle difference into a converting model 300 to obtain a feature cuboid 330, which represents features of the incident angle difference and whose size is the same as the feature cuboid 240 along the second azimuth-axis 152 and the second range-axis 154. The converting model 300 includes an embedding layer 310 and an encoding layer 320. The embedding layer 310 and the encoding layer 320 may be implemented as machine learning-based model, such as neural networks, and therefore be trainable.

The embedding layer 310 is configured to take the quantized incident angle difference as input, and converting the input data into a random number that encodes the incident angle difference. The embedding layer 310 is trained to map each integer obtained by the quantization of the incident angle difference to a specific random number. In other words, each bin of the quantized incident angle difference is associated with a specific random number through the training of the embedding layer 310.

The computed random number is output as a vector, and input to the encoding layer 320. The encoding layer 320 is configured to perform transposed convolution on the input vector to generate the feature cuboid 330.

The features of the azimuth angle difference are computed in a way similar to the way of computing the features of the incident angle difference. The transforming unit 2060 computes the azimuth angle difference (i.e., the difference between the first azimuth angle 34 and the second azimuth angle 94) and quantizes the azimuth angle difference to obtain one of predefined integers. Then, the transforming unit 2060 inputs the quantized azimuth angle difference into a converting model 340 to obtain a feature cuboid 370, which represents features of the azimuth angle difference and whose size is the same as the feature cuboid 240 along the second azimuth-axis 152 and the second range-axis 154. The converting model 340 includes an embedding layer 350 and an encoding layer 360. The embedding layer 350 and the encoding layer 360 may be implemented as machine learning-based model, such as neural networks, and therefore be trainable.

The embedding layer 350 is configured to take the quantized azimuth angle difference as input, and converting the input data into a random number that encodes the azimuth angle difference. Each bin of the quantized azimuth angle difference is associated with a specific random number through the training of the embedding layer 350. The computed random number is output as a vector, and input to the encoding layer 360. The encoding layer 360 is configured to perform transposed convolution on the input vector to generate the feature cuboid 370.

After computing the feature cuboid 330 and the feature cuboid 370, the transforming unit 2060 concatenates them to obtain the feature cuboid 270, which represents the features of the set of the first angle information 30 and the second angle information 90.

### <Update of Model Set 50: S110>

The updating unit 2100 updates the model set 50 using the first feature set 80 and the second feature set 100 (S110). Specifically, the updating unit 2100 inputs the first feature set 80 into the task executing model 54 and obtains a result of the task from the task executing model 54. Then, the updating unit 2100 computes a loss based on the ground truth data 40 and the result of the task performed with the first feature set 80. Similarly, the updating unit 2100 inputs the second feature set 100 into the task executing model 54 and obtains a result of the task from the task executing model 54. Then, the updating unit 2100 computes a loss based on the ground truth data 40 and the result of the task performed with the second feature set 100. When two or more second feature sets 100 are generated by the transforming unit 2080, the updating unit 2100 may compute the loss for each of the second feature sets 100.

The computed losses are used to train the model set 50. There may be various ways to train models based on losses, and one of those ways can be applied to the updating unit 2100. For example, the updating unit 2100 may compute a batch loss with the computed losses (e.g., compute an average of the computed losses) and update trainable parameters of the model set 50 using the batch loss. In another example, the updating unit 2100 may separately use each of the computed losses to update the trainable parameters of the model set 50.

When the transforming unit 2060 includes the feature modifying model 250, the updating unit 2100 may also use the computed loss to update the trainable parameters (e.g., weights for computing the weighted sum mentioned above) of the feature modifying model 250. Similarly, when the transforming unit 2060 includes the converting model 300 and the converting model 340, the updating unit 2100 may also use the computed loss to update the trainable parameters of the converting model 300 and those of the converting model 340. In another example, the feature modifying model 250, the converting model 300, and the converting model 340 may be trained in advance of training the model set 50.

<Output from Training Apparatus 2000>

The training apparatus 2000 may output the result of the training of the model set 50. The result of the training may be output in an arbitrary manner. For example, the training apparatus 2000 may save trained parameters (e.g., weights assigned to respective connections of neural networks) of the model set 50 on a storage unit. In another example, the training apparatus 2000 may send the trained parameters to another apparatus that is used to run the model set 50. It is noted that not only the parameters but also the program implementing the model set 50 may be output.

In the case where the training apparatus 2000 is also used to run the model set 50 in an operation phase of the model set 50, the training apparatus 2000 may not output the result of the training. In this case, from the viewpoint of the user of the training apparatus 2000, it is preferable that the training apparatus 2000 notifies the user that the training of the model set 50 has finished.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### <Supplementary Notes>

### (Supplementary Note 1)

A training apparatus comprising:
at least one memory that is configured to store instructions; and
at least one processor that is configured to execute the instructions to:
acquire a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image; input the training image to a feature extracting model to acquire a first feature set that is a set of features extracted from the training image; acquire second angle information that indicates a second incident angle and a second azimuth angle, wherein the second incident angle, the second azimuth angle, or both are different from counterparts thereof in the first angle information;
generate a second feature set by performing coordinate transformation on the first feature set based on the first angle information and the second angle information; and
update the feature extracting model based on the first feature set, the second feature set, and the ground truth data.

### (Supplementary Note 2)

The training apparatus according to supplementary note 1,
wherein the first feature set is represented by a set of cells each of which has a value of features and coordinates in a first coordinate system that is defined using the first incident angle,
wherein the second feature set is represented by a set of cells each of which has a value of features and coordinates in a second coordinate system that is defined using the second incident angle, the first azimuth angle, and the second azimuth angle, and
wherein the performing of the coordinate transformation on the first feature set includes:
performing, for each cell of the first feature set, coordinate transformation from the first coordinate system to the second coordinate system on coordinates of the cell of the first feature set to compute a corresponding cell of the second feature set; and
setting the value of the cell of the first feature set to the corresponding cell of the second feature set.

### (Supplementary Note 3)

The training apparatus according to supplementary note 2,
wherein the coordinate transformation from the first coordinate system to the second coordinate system includes:
a transformation from the first coordinate system to a world coordinate system that is defined by a ground plane and an elevation axis that represents a direction opposite to a gravity direction;
a rotation of the world coordinate system by a rotation angle around the elevation axis, wherein the rotation angle is a difference between the first azimuth angle and the second azimuth angle; and
a transformation from the world coordinate system rotated by the rotation angle to the second coordinate system.

### (Supplementary Note 4)

The training apparatus according to supplementary note 1,
wherein the first feature set is represented by a first set of cells each of which has a value of features and coordinates in a first coordinate system that is defined using the first incident angle,
wherein the second feature set is represented by a second set of cells each of which has a value of features and coordinates in a second coordinate system that is defined using the second incident angle, the first azimuth angle, and the second azimuth angle, and
wherein the generating of the second feature set includes:
performing the coordinate transformation on the first feature set to transform the first feature set into a third set of cells in the second coordinate system; and
modifying the value of one or more cells of the third set generate the second feature set.

### (Supplementary Note 5)

The training apparatus according to supplementary note 4,
wherein the generating of the second feature set includes:
computing features of difference between the first angle information and the second angle information; and
modifying the value of one or more cells of the third set using the features of difference between the first angle information and the second angle information.

### (Supplementary Note 6)

The training apparatus according to supplementary note 1,
wherein the training image is a radar image that is generated by a radar.

### (Supplementary Note 7)

The training apparatus according to supplementary note 6,
wherein the first feature set represents, for each sub-region on the training image, features of backscattering at each of two or more points that are projected on the sub-region on an image plane of the training image along a line that forms the first incident angle from the image plane.

### (Supplementary Note 8)

The training apparatus according to supplementary note 1,
wherein the updating of the feature extracting model includes:
inputting the first feature set into a task executing model to acquire a first result of a task;
inputting the second feature set into the task executing model to acquire a second result of the task;
computing one or more losses based on the first result of the task, the second result of the task, and the ground truth data; and
updating trainable parameters of the feature extracting model and the task executing model based on the one or more losses.

### (Supplementary Note 9)

A training method performed by a computer, comprising:
acquiring a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image; inputting the training image to a feature extracting model to acquire a first feature set that is a set of features extracted from the training image;
acquiring second angle information that indicates a second incident angle and a second azimuth angle, wherein the second incident angle, the second azimuth angle, or both are different from counterparts thereof in the first angle information;
generating a second feature set by performing coordinate transformation on the first feature set based on the first angle information and the second angle information; and
updating the feature extracting model based on the first feature set, the second feature set, and the ground truth data.

### (Supplementary Note 10)

The training method according to supplementary note 9,
wherein the first feature set is represented by a set of cells each of which has a value of features and coordinates in a first coordinate system that is defined using the first incident angle,
wherein the second feature set is represented by a set of cells each of which has a value of features and coordinates in a second coordinate system that is defined using the second incident angle, the first azimuth angle, and the second azimuth angle, and
wherein the performing of the coordinate transformation on the first feature set includes:
performing, for each cell of the first feature set, coordinate transformation from the first coordinate system to the second coordinate system on coordinates of the cell of the first feature set to compute a corresponding cell of the second feature set; and
setting the value of the cell of the first feature set to the corresponding cell of the second feature set.

### (Supplementary Note 11)

The training method according to supplementary note 10,
wherein the coordinate transformation from the first coordinate system to the second coordinate system includes:
a transformation from the first coordinate system to a world coordinate system that is defined by a ground plane and an elevation axis that represents a direction opposite to a gravity direction;
a rotation of the world coordinate system by a rotation angle around the elevation axis, wherein the rotation angle is a difference between the first azimuth angle and the second azimuth angle; and
a transformation from the world coordinate system rotated by the rotation angle to the second coordinate system.

### (Supplementary Note 12)

The training method according to supplementary note 9,
wherein the first feature set is represented by a first set of cells each of which has a value of features and coordinates in a first coordinate system that is defined using the first incident angle,
wherein the second feature set is represented by a second set of cells each of which has a value of features and coordinates in a second coordinate system that is defined using the second incident angle, the first azimuth angle, and the second azimuth angle, and
wherein the generating of the second feature set includes:
performing the coordinate transformation on the first feature set to transform the first feature set into a third set of cells in the second coordinate system; and
modifying the value of one or more cells of the third set to generate the second feature set.

### (Supplementary Note 13)

The training method according to supplementary note 12,
wherein the generating of the second feature set includes:
computing features of difference between the first angle information and the second angle information; and
modifying the value of one or more cells of the third set using the features of difference between the first angle information and the second angle information.

### (Supplementary Note 14)

The training method according to supplementary note 9,
wherein the training image is a radar image that is generated by a radar.

### (Supplementary Note 15)

The training method according to supplementary note 14,
wherein the first feature set represents, for each sub-region on the training image, features of backscattering at each of two or more points that are projected on the sub-region on an image plane of the training image along a line that forms the first incident angle from the image plane.

### (Supplementary Note 16)

The training method according to supplementary note 9,
wherein the updating of the feature extracting model includes:
inputting the first feature set into a task executing model to acquire a first result of a task;
inputting the second feature set into the task executing model to acquire a second result of the task;
computing one or more losses based on the first result of the task, the second result of the task, and the ground truth data; and
updating trainable parameters of the feature extracting model and the task executing model based on the one or more losses.

### (Supplementary Note 17)

A non-transitory computer-readable storage medium storing a computer that causes a computer to execute:
acquiring a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image; inputting the training image to a feature extracting model to acquire a first feature set that is a set of features extracted from the training image;
acquiring second angle information that indicates a second incident angle and a second azimuth angle, wherein the second incident angle, the second azimuth angle, or both are different from counterparts thereof in the first angle information;
generating a second feature set by performing coordinate transformation on the first feature set based on the first angle information and the second angle information; and
updating the feature extracting model based on the first feature set, the second feature set, and the ground truth data.

### (Supplementary Note 18)

The storage medium according to supplementary note 17,
wherein the first feature set is represented by a set of cells each of which has a value of features and coordinates in a first coordinate system that is defined using the first incident angle,
wherein the second feature set is represented by a set of cells each of which has a value of features and coordinates in a second coordinate system that is defined using the second incident angle, the first azimuth angle, and the second azimuth angle, and
wherein the performing of the coordinate transformation on the first feature set includes:
performing, for each cell of the first feature set, coordinate transformation from the first coordinate system to the second coordinate system on coordinates of the cell of the first feature set to compute a corresponding cell of the second feature set; and
setting the value of the cell of the first feature set to the corresponding cell of the second feature set.

### (Supplementary Note 19)

The storage medium according to supplementary note 18,
wherein the coordinate transformation from the first coordinate system to the second coordinate system includes:
a transformation from the first coordinate system to a world coordinate system that is defined by a ground plane and an elevation axis that represents a direction opposite to a gravity direction;
a rotation of the world coordinate system by a rotation angle around the elevation axis, wherein the rotation angle is a difference between the first azimuth angle and the second azimuth angle; and
a transformation from the world coordinate system rotated by the rotation angle to the second coordinate system.

### (Supplementary Note 20)

The storage medium according to supplementary note 17,
wherein the first feature set is represented by a first set of cells each of which has a value of features and coordinates in a first coordinate system that is defined using the first incident angle,
wherein the second feature set is represented by a second set of cells each of which has a value of features and coordinates in a second coordinate system that is defined using the second incident angle, the first azimuth angle, and the second azimuth angle, and
wherein the generating of the second feature set includes:
performing the coordinate transformation on the first feature set to transform the first feature set into a third set of cells in the second coordinate system; and
modifying the value of one or more cells of the third set to generate the second feature set.

### (Supplementary Note 21)

The storage medium according to supplementary note 20,
wherein the generating of the second feature set includes:
computing features of difference between the first angle information and the second angle information; and
modifying the value of one or more cells of the third set using the features of difference between the first angle information and the second angle information.

### (Supplementary Note 22)

The training method according to supplementary note 17,
wherein the training image is a radar image that is generated by a radar.

### (Supplementary Note 23)

The storage medium according to supplementary note 22,
wherein the first feature set represents, for each sub-region on the training image, features of backscattering at each of two or more points that are projected on the sub-region on an image plane of the training image along a line that forms the first incident angle from the image plane.

### (Supplementary Note 24)

The storage medium according to supplementary note 17,
wherein the updating of the feature extracting model includes: inputting the first feature set into a task executing model to acquire a first result of a task;
inputting the second feature set into the task executing model to acquire a second result of the task;
computing one or more losses based on the first result of the task, the second result of the task, and the ground truth data; and
updating trainable parameters of the feature extracting model and the task executing model based on the one or more losses.

### REFERENCE SIGNS LIST

10 training data
20 training image
22 object
30 first angle information
32 first incident angle
34 first azimuth angle
40 ground truth data
50 model set
52 feature extracting model
54 task executing model
70 sensor
75 radar
80 first feature set
90 second angle information
92 second incident angle
94 second azimuth angle
100 second feature set
130 first coordinate system
132 first azimuth-axis
134 first range-axis
136 first incident-axis
140 world coordinate system
146 elevation-axis
150 second coordinate system
152 second azimuth-axis
154 second range-axis
156 second incident-axis
160 line
200 image
210 sub-region
220 feature cuboid
230 sequence
240 feature cuboid
250 feature modifying model
260 feature cuboid
270 feature cuboid
280 feature cuboid
290 feature cuboid
300 converting model
310 embedding layer
320 encoding layer
330 feature cuboid
340 converting model
350 embedding layer
360 encoding layer
370 feature cuboid
1000 computer
1020 bus
1040 processor
1060 memory
1080 storage device
1100 input/output interface
1120 network interface
2000 training apparatus
2020 training data acquiring unit
2040 angle information acquiring unit
2060 feature acquiring unit
2080 transforming unit
2100 updating unit

What is claimed is:

1. A training apparatus comprising:
at least one memory that is configured to store instructions; and
at least one processor that is configured to execute the instructions to:
acquire a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image;
input the training image to a feature extracting model to acquire a first feature set that is a set of features extracted from the training image;
acquire second angle information that indicates a second incident angle and a second azimuth angle, wherein the second incident angle, the second azimuth angle, or both are different from counterparts thereof in the first angle information;
generate a second feature set by performing coordinate transformation on the first feature set based on the first angle information and the second angle information; and
update the feature extracting model based on the first feature set, the second feature set, and the ground truth data.

2. The training apparatus according to claim 1,
wherein the first feature set is represented by a set of cells each of which has a value of features and coordinates in a first coordinate system that is defined using the first incident angle,
wherein the second feature set is represented by a set of cells each of which has a value of features and coordinates in a second coordinate system that is defined using the second incident angle, the first azimuth angle, and the second azimuth angle, and
wherein the performing of the coordinate transformation on the first feature set includes:
performing, for each cell of the first feature set, coordinate transformation from the first coordinate system to the second coordinate system on coordinates of the cell of the first feature set to compute a corresponding cell of the second feature set; and
setting the value of the cell of the first feature set to the corresponding cell of the second feature set.

3. The training apparatus according to claim 2,
wherein the coordinate transformation from the first coordinate system to the second coordinate system includes:
a transformation from the first coordinate system to a world coordinate system that is defined by a ground plane and an elevation axis that represents a direction opposite to a gravity direction;
a rotation of the world coordinate system by a rotation angle around the elevation axis, wherein the rotation angle is a difference between the first azimuth angle and the second azimuth angle; and
a transformation from the world coordinate system rotated by the rotation angle to the second coordinate system.

4. The training apparatus according to claim 1,
wherein the first feature set is represented by a first set of cells each of which has a value of features and coordinates in a first coordinate system that is defined using the first incident angle,
wherein the second feature set is represented by a second set of cells each of which has a value of features and coordinates in a second coordinate system that is defined using the second incident angle, the first azimuth angle, and the second azimuth angle, and
wherein the generating of the second feature set includes:
performing the coordinate transformation on the first feature set to transform the first feature set into a third set of cells in the second coordinate system; and
modifying the value of one or more cells of the third set to generate the second feature set.

5. The training apparatus according to claim 4,
wherein the generating of the second feature set includes:
computing features of difference between the first angle information and the second angle information; and
modifying the value of one or more cells of the third set using the features of difference between the first angle information and the second angle information.

6. The training apparatus according to claim 1,
wherein the training image is a radar image that is generated by a radar.

7. The training apparatus according to claim 6,
wherein the first feature set represents, for each sub-region on the training image, features of backscattering at each of two or more points that are projected on the sub-region on an image plane of the training image along a line that forms the first incident angle from the image plane.

8. The training apparatus according to claim 1,
wherein the updating of the feature extracting model includes:
inputting the first feature set into a task executing model to acquire a first result of a task;
inputting the second feature set into the task executing model to acquire a second result of the task;
computing one or more losses based on the first result of the task, the second result of the task, and the ground truth data; and
updating trainable parameters of the feature extracting model and the task executing model based on the one or more losses.

9. A training method performed by a computer, comprising:
acquiring a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image;
inputting the training image to a feature extracting model to acquire a first feature set that is a set of features extracted from the training image;
acquiring second angle information that indicates a second incident angle and a second azimuth angle, wherein the second incident angle, the second azimuth angle, or both are different from counterparts thereof in the first angle information;
generating a second feature set by performing coordinate transformation on the first feature set based on the first angle information and the second angle information; and
updating the feature extracting model based on the first feature set, the second feature set, and the ground truth data.

10. The training method according to claim 9,
wherein the first feature set is represented by a set of cells each of which has a value of features and coordinates in a first coordinate system that is defined using the first incident angle,
wherein the second feature set is represented by a set of cells each of which has a value of features and coordinates in a second coordinate system that is defined using the second incident angle, the first azimuth angle, and the second azimuth angle, and
wherein the performing of the coordinate transformation on the first feature set includes:
performing, for each cell of the first feature set, coordinate transformation from the first coordinate system to the second coordinate system on coordinates of the cell of the first feature set to compute a corresponding cell of the second feature set; and
setting the value of the cell of the first feature set to the corresponding cell of the second feature set.

11. The training method according to claim 10,
wherein the coordinate transformation from the first coordinate system to the second coordinate system includes:
a transformation from the first coordinate system to a world coordinate system that is defined by a ground plane and an elevation axis that represents a direction opposite to a gravity direction;
a rotation of the world coordinate system by a rotation angle around the elevation axis, wherein the rotation angle is a difference between the first azimuth angle and the second azimuth angle; and
a transformation from the world coordinate system rotated by the rotation angle to the second coordinate system.

12. The training method according to claim 9,
wherein the first feature set is represented by a first set of cells each of which has a value of features and coordinates in a first coordinate system that is defined using the first incident angle,
wherein the second feature set is represented by a second set of cells each of which has a value of features and coordinates in a second coordinate system that is defined using the second incident angle, the first azimuth angle, and the second azimuth angle, and
wherein the generating of the second feature set includes:
performing the coordinate transformation on the first feature set to transform the first feature set into a third set of cells in the second coordinate system; and
modifying the value of one or more cells of the third set to generate the second feature set.

13. The training method according to claim 12,
wherein the generating of the second feature set includes:
computing features of difference between the first angle information and the second angle information; and
modifying the value of one or more cells of the third set using the features of difference between the first angle information and the second angle information.

14. The training method according to claim 9,
wherein the training image is a radar image that is generated by a radar.

15-16. (canceled)

17. A non-transitory computer-readable storage medium storing a program that causes a computer to execute:
acquiring a training data that includes a training image, first angle information, and a ground truth data, wherein the training image is an image on which an object is captured and which is generated by a sensor, and wherein the first angle information indicates a first incident angle that is an incident angle of the sensor and a first azimuth angle that is an azimuth angle of the object captured on the training image;
inputting the training image to a feature extracting model to acquire a first feature set that is a set of features extracted from the training image;
acquiring second angle information that indicates a second incident angle and a second azimuth angle, wherein the second incident angle, the second azimuth angle, or both are different from counterparts thereof in the first angle information;
generating a second feature set by performing coordinate transformation on the first feature set based on the first angle information and the second angle information; and
updating the feature extracting model based on the first feature set, the second feature set, and the ground truth data.

18. The storage medium according to claim 17,
wherein the first feature set is represented by a set of cells each of which has a value of features and coordinates in a first coordinate system that is defined using the first incident angle,
wherein the second feature set is represented by a set of cells each of which has a value of features and coordinates in a second coordinate system that is defined using the second incident angle, the first azimuth angle, and the second azimuth angle, and
wherein the performing of the coordinate transformation on the first feature set includes:
performing, for each cell of the first feature set, coordinate transformation from the first coordinate system to the second coordinate system on coordinates of the cell of the first feature set to compute a corresponding cell of the second feature set; and
setting the value of the cell of the first feature set to the corresponding cell of the second feature set.

19. The storage medium according to claim 18,
wherein the coordinate transformation from the first coordinate system to the second coordinate system includes:
a transformation from the first coordinate system to a world coordinate system that is defined by a ground plane and an elevation axis that represents a direction opposite to a gravity direction;
a rotation of the world coordinate system by a rotation angle around the elevation axis, wherein the rotation angle is a difference between the first azimuth angle and the second azimuth angle; and
a transformation from the world coordinate system rotated by the rotation angle to the second coordinate system.

20. The storage medium according to claim 17,
wherein the first feature set is represented by a first set of cells each of which has a value of features and coordinates in a first coordinate system that is defined using the first incident angle,
wherein the second feature set is represented by a second set of cells each of which has a value of features and coordinates in a second coordinate system that is defined using the second incident angle, the first azimuth angle, and the second azimuth angle, and
wherein the generating of the second feature set includes:
performing the coordinate transformation on the first feature set to transform the first feature set into a third set of cells in the second coordinate system; and
modifying the value of one or more cells of the third set to generate the second feature set.

21. The storage medium according to claim 20,
wherein the generating of the second feature set includes:
computing features of difference between the first angle information and the second angle information; and
modifying the value of one or more cells of the third set using the features of difference between the first angle information and the second angle information.

22. The storage medium according to claim 17,
wherein the training image is a radar image that is generated by a radar.

23-24. (canceled)
